(19) United States
(12) Patent Application Publication
(10) Pub. No.: US 2022/0012700 A1
(43) Pub. Date: Jan. 13, 2022

(54) Peer to Peer Electronic Data Exchange

(71) Applicant: Altaf HADI, Sachse, TX (US)

(72) Inventor: Altaf HADI, Sachse, TX (US)

(21) Appl. No.: 17/486,822

(22) Filed: Sep. 27, 2021

Related U.S. Application Data
(63) Continuation of application No. 16/602,585, filed on Nov. 5, 2019.
(60) Provisional application No. 62/755,997, filed on Nov. 5, 2018.
(60) Provisional application No. 62/819,383, filed on Mar. 15, 2019.

(51) Int. Cl. G06Q 20/06; G06Q 20/22

(52) U.S. Cl. CPC G06Q 20/0655; G06Q 20/223

(57) ABSTRACT

A system and method for generating, issuing and recording value transactions n a peer to peer data exchange based on proof of data blockchain. The system includes enabling users to open datastores and receive value and the value transactions recorded on the proof of data blockchain, wherein the recorder of value competes to obtain blockchain recording rights by issuing value to users obtaining the highest proof of data score, wherein the recording blocks are of variable size.

### CROSS REFERENCE TO RELATED APPLICATIONS

This application is a continuation under 35 U.S.C. § 111(a) of U.S. patent application Ser. No. 16/602,585 filed on Nov. 5, 2019 which claims the benefit of U.S. Provisional Applications No. 62/755,997 filed on Nov. 5, 2018 and 62/819,383 filed on Mar. 15, 2019, the contents of which are hereby incorporated by reference.

### TECHNICAL FIELD

This disclosure generally relates to generating and issuing value to users, and more particularly to proof of data consensus based blockchain recorders recording transactions on variable size blocks real and near real time.

### BACKGROUND OF THE INVENTION

Data has emerged as the new Oil. Facebook, Google and many other organizations earn large sums of money based on user data yet users do not obtain monetary benefits from their data.

Consumer privacy exists in theory only; all aspects of consumer life, even the most private and intimate details are harvested by stealth of artificial intelligence technologies.

Cryptocurrency is feared, misunderstood and down-played as money launderer's dream. Detractors tout that the crypto market has lost value since peaking in December 2017. In comparison, the US Dollar remains the global currency of choice for money laundering while it continues to lose purchasing power making Americans poorer and poorer every day. In 1953 1USD=4.3 Swiss Franc, in 2018 1USD fell to as low as 0.92 Swiss Franc resulting in more than 78% value decline during this period.

There is a grave concern that proof of work-based cryptocurrencies are contributing to global warming. “Bitcoin emissions alone could push global warming above 2° C.” warns the October 2018 research report issued by Nature Climate Change—a monthly peer-reviewed scientific journal. Forbes magazine bull-horned the report's findings as “Bitcoin predicted to be the nail in the coffin of climate change”. Although critics such as Dr. Jon Koomey a Lawrence Berkeley National Laboratory scientist explains calculations of bitcoin energy use are complicated. However, one cannot deny the excess energy consumed by bitcoin and other proof of work cryptocurrency mining and its continued impact on the environment. Even when the energy used in proof of work cryptocurrencies come from green sources, such colossal energy if redirected can support making clean water for more than 750 million people and avert 2 to 5 million deaths needleless deaths due to contaminated drinking water.

It therefore is beneficial to humanity at large to provide effective solutions to safeguard user privacy, help monetize their data, eliminate the energy waste from existing cryptocurrencies and anonymize and make transactions immutable.

Despite the hype, cryptocurrency adoption in real commerce is nonexistent on a global scale.

The present innovation comprises of a peer-to-peer decentralized cryptocurrency and data exchange, underpinned by proof of data based trustless blockchain orchestrating permission-less cryptocurrency transactions for delivering business to business, business to consumer, and consumer to consumer transactions. The eco-system enables users to create sovereign datastores and monetize the content of their datastore perpetually. Neither the entity or entities managing the said eco-system nor any government agency can access the user data assets without their explicit consent subject to monetary terms.

The consensus on the eco-system 8lockchain is based on proof of data algorithm. Furthermore, transactions on the distributed proof of data blockchain settles in real and near real-time. The peer-to-peer data exchange eco-system cryptocurrency, bitcoin data, satisfies the definition of money namely unit of account, medium of exchange and store of value.

The permission-less eco-system cryptocurrency can be pegged to a desired world currency the bitcoin data coins split into half when the value reaches or exceeds the baselined peg of the selected government issued currency. Coins increase in number with value increase; coin quantity remains unchanged when value decreases.

### BRIEF SUMMARY OF THE INVENTION

This disclosure describes various embodiments of a peer-to-peer electronic data exchange.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent to those skilled in the art from the following detailed description taken in conjunction with the accompanying drawings.

FIG. 1 describes the various disclosed embodiments of the peer-to-peer electronic data exchange.

FIG. 2 describes the generation of the immutable transaction identification number generation.

FIG. 3 describes the various disclosed embodiments of the datastore.

### DETAILED DESCRIPTION OF THE INVENTION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon.

### Description of Example Embodiments

As used herein, the functional terminology of “main chain”, proof of data based blockchain and distributed blockchain can be used interchangeably. The term “witness chain layer” and “datastore layer” can be used interchangeably. The term “datastore” encompasses a sub eco-system of the peer-to-peer electronic data exchange comprising of multiple sub systems. The term “bitcoin data” and “BTD” is used interchangeably. The term “data truth index” and “DTI” is used interchangeably. The term “vote”, “voting”, constituents are used interchangeably. The terms “user datastore estate” and “user technology estate” are used interchangeably. The terms “dAPPs” and “decentralized applications” are used interchangeably.

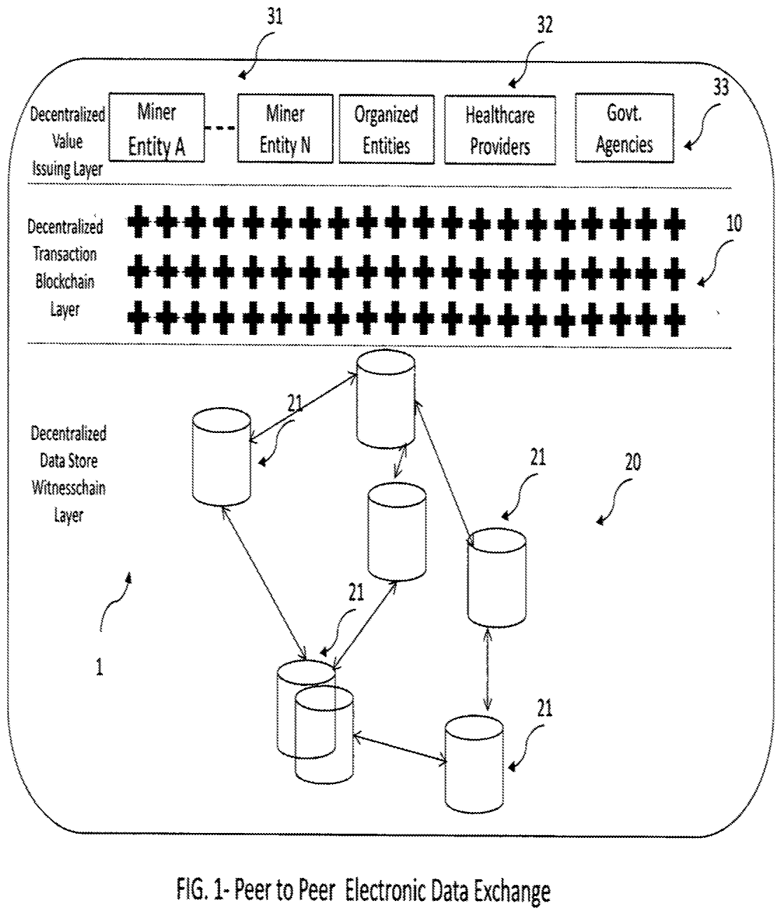

FIG. 1 illustrates an example peer-to-peer electronic data exchange 1. Embodiments of the peer-to-peer electronic exchange invention includes a decentralized blockchain transaction layer 10 that records the eco-system transactions and data hashes; this layer may be referred to as main chain. The records of transactions and data hashes are recorded and archived in variable size blocks at this layer in the peer-to-peer electronic data exchange eco-system. The transactions at this layer are recorded in real-time and near real-time.

The miner may broadcast the block shards to the bitcoin data network upon mining one or more transactions. Said transaction structure of the bitcoin data transaction format is akin to bitcoin transactions of the prior art.

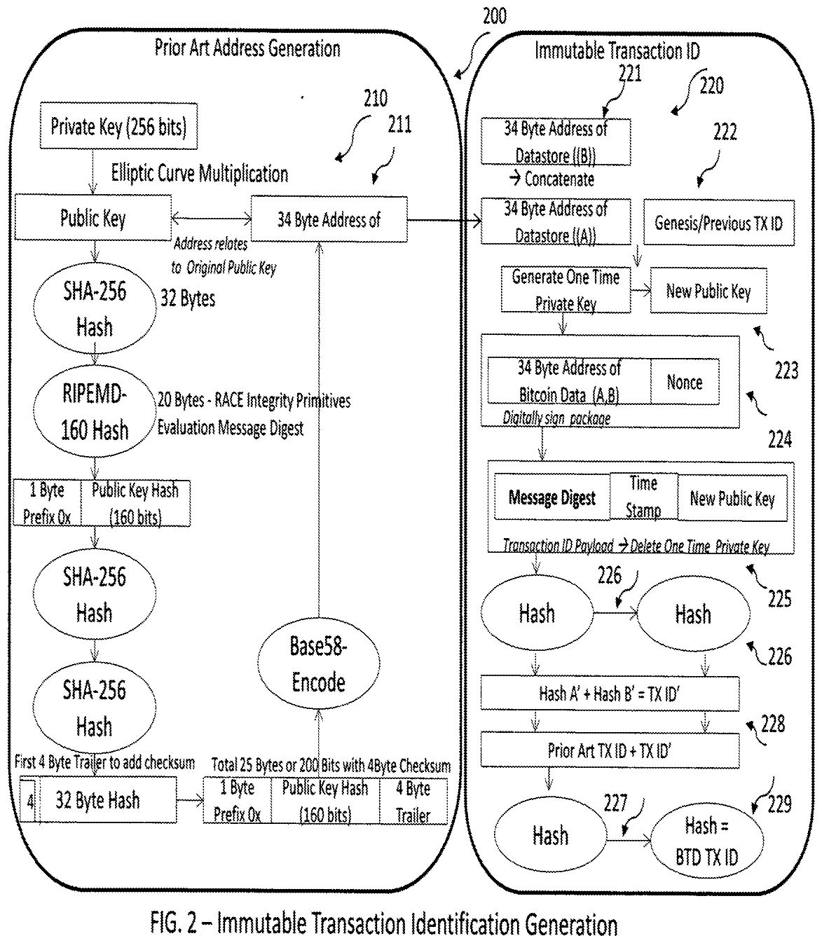

The bitcoin data transaction identification number is obtained by subjecting the prior art transaction identification number to the immutable transaction identification generation process of FIG. 2.

The bitcoin data decentralized blockchain network layer functions akin to known art bitcoin network wherein the bitcoin data network's catalytic improvements includes, but not limited to, generating, harvesting and delivering value to users from their intrinsic data assets, an energy efficient proof of data consensus algorithm, an immutable transaction identification number generation, a variable block size ledger for mining transactions in real and near-real time enhancing said network's cryptocurrency adoption in commerce, adoption of the said network for business and consumer interaction amongst and between each other requiring proof of an event occurring.

Datastore owners may choose to become full nodes, super nodes, light nodes or mining nodes akin to the nodes of the known art. Said full and super nodes takes on voluntary obligation for verifying the block winners, verifying the transactions and for maintaining and distributing copies of the entire blockchain ledger.

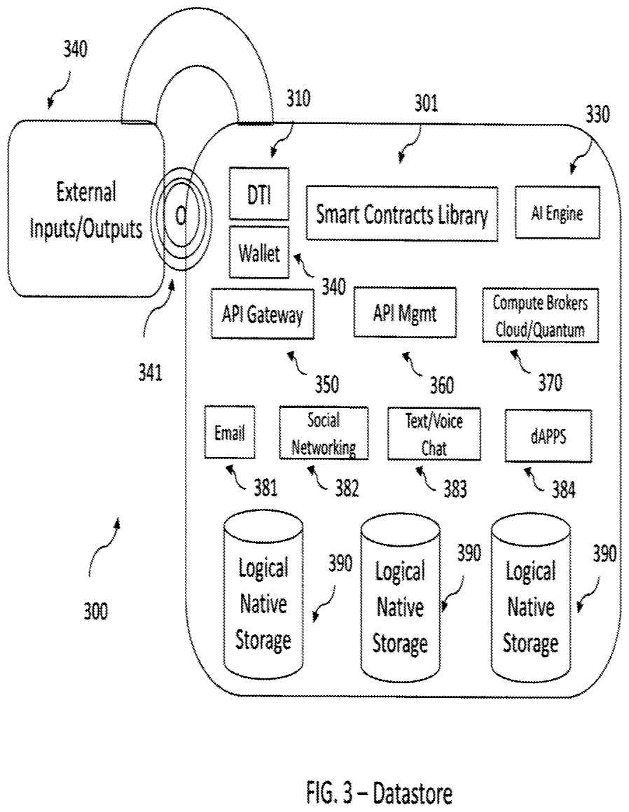

Light nodes may hold a portion of the blockchain ledger and recent block transactions to confirm the truthfulness of the transactions. The wallet 340 of FIG. 3 is an example embodiment of light node.

In addition to said mining nodes of the eco-system of FIG. 1 light nodes, full nodes and super nodes broadcast the transactions on the bitcoin data network.

The entities A through N 31 of the said peer-to-peer eco system of FIG. 1 issues value in the form of cryptocurrency, said cryptocurrency is termed “BTD or bitcoin data”.

The consensus algorithm in the said eco-system of FIG. 1 is based on proof of data.

When users join the said eco-system of FIG. 1, a “user datastores” 20 is created in the datastore witness chain layer with zero data truth index, the DTI score. The DTI score is based on authentic user data; the accumulation of the DTI index commences when users provide authentic identification credentials and an initial set of authentic demographic data. Based on this data, the said eco-system of FIG. 1 DTI analyzing artificial engine algorithm assigns an opening DTI score to the user data; the user datastore of FIG. 3 reflects this DTI score 310.

The Data Truth Index or DTI score is based on, but not limited to, comprising of: notarized or non-notarized driver license, passport, state issued identification, direct deposit of identification credentials by government agencies 33, direct deposit of DNA data by health agencies 32, identification value confirmed by employer, legacy financial institutions or a combination thereof 31; identification vouched by fellow eco-system users; demographics data, behavior data, health data, global positioning system data or GPS data, call record data, and online history data; freshness of data; quality and quantity of data.

Organized entities DTI score is calculated to be zero for the purpose of contributing to the Proof of Data (PoD) Ω score. Said organized entities zero score is based upon the authenticity of its business licenses, age of licenses and additional criterion including but not limited to past and present lawsuits, bankruptcy proceedings, fraud court cases and allied artifacts. Till such time the organized entities furnish above said details their DTI score remains negative one, −1.

For individual datastore owners, the DTI score is measured on a scale of 0 to 1. Upon reaching a base wealth germination threshold, users can begin to monetize their data. Based on the available data in the user datastore, the peer-to-peer electronic data exchange eco-system of FIG. 1 assigns an expected yearly data harvest value to the user data.

Akin to the early days of the bitcoin network of known art, till such time when token holders with sufficient BTD token holdings emerge and compete to issue value for user data, the peer-to-peer electronic data exchange eco-system of FIG. 1 issues value in the native bitcoin data cryptocurrency termed basetokens. The unspent output UTXO basetokens are recorded on the decentralized transaction blockchain layer 10.

Upon issuing the basetoken BTD, the value issuing entity 31 garners a set score and presents it to the network for winning the proof of data consensus competition. Said value issuing entities obtain rights to monetize and issue additional BTD value to users of datastore for a prescribed period of time as governed by the Smart Contracts Library 301 of FIG. 3.

Datastore owners 21 signing up to receive basetokens from a value issuing entity 31 become constituents of the said miner thereby enabling the value issuing entities 31 to start accumulating PoD Ω score to compete and win the rights to mine the next block.

Individual datastore owners with sufficient BTD net worth can compete to become miners by issuing value.

A value issuing entity 31 who competed, garnered and proved receiving the highest Ω score during the time window t−1 and time t by issuing basetokens to users for rights to monetize user data assets has won the rights to mine the next block at time t and earn transaction fees.

In the said peer-to-peer electronic data exchange eco-system of FIG. 1, the block mining window δ is of standard time duration.

Proof of data-based consensus is the accumulation of the highest Ω score during the immediate last block mining window δ.

During time window δ, n new user datastores are created having attained a threshold DTI with a combined DTI score of a where ß₁, ß₂, ß₃, . . . are the individual DTI of n and where n′⊂n. Thus,

$$α = {\sum }_{i = 1}^{k} {n}_{i} and Ω = {\sum }_{i = 1}^{k} {n}_{i}^{′}$$

Ω score is the sum of ß₁, ß₂, . . . in the set n′; thus, Ω<=α.

The value issuing entity 31 with the highest Proof of Data Ω score will earn the right to mine the next block at time t.

The blockchain 10 of the peer-to-peer electronic data exchange eco-system of FIG. 1 is permission less; whereby token holders with sufficient BTD net worth can compete to win the mining rights by accumulating the highest PoD Ω score to mine the next block.

The value issuing entity miners 31 winning the rights to mine the next block earn transaction fees for recording the transaction on the blockchain 10 of the said eco-system of FIG. 1.

Verification of the next block winner is established by all eco-system full nodes, super nodes and participating light nodes verifying the smart contract record transaction on the blockchain 10 of user datastore during the block mining window δ wherein the datastore owners have given their consent by voting to a said miner and receiving a sum of basetokens.

The peer-to-peer electronic data exchange eco-system of FIG. 1 arbitrates contending proof of data Ω score winners based on but not limited to: total number of times the winning node failed during active block mining window, the lower the number the higher the weightage; total number of datastore users signed up with a particular contender, the more the number, the higher the weightage; the time it took the user datastore to attain wealth germination DTI threshold, the lower the time the higher the weightage; the net worth of the user datastore excluding any basetoken BTD issued by the contender, the higher the worth the higher the weightage; the expected yearly income of the user datastore, the more the worth the higher the weightage; the net BTD worth of the contenders, the higher the worth the higher the weightage; the datastore age of the contenders, the higher the worth the higher the weightage; the individual user versus an organized entity status of the contenders, individual status contender has more weightage; the number of times a contender has won block mining rights prior to time t, the higher the number the higher the weightage; when last a contender has won the block mining rights prior to time t, the closest to time t the higher the weightage; the DTI score of the contenders, the higher the DTI score the higher the weightage, on this metric the DTI of organized entities is negative one; the number of basetokens a contender has issued prior to time t, the higher the basetokens the higher the weightage; the earliest the contender has issued basetokens, the earliest the issuance the higher the weightage; the net BTD worth of the contender at time t, the higher the worth the higher the weightage; the total BTD value of the transactions not recorded in real-time by the winner before the creation of the next block, the lower the value the higher the weightage.

The eco-system of FIG. 1 offers zero block reward for miners obtaining the highest proof of data Ω score.

The said eco-system of FIG. 1 sells a limited quantity of BTD tokens at the token generation event.

Till such time sufficient miners emerge, the said peer-to-peer electronic data exchange eco-system of FIG. 1 airdrops BTD tokens to datastore users upon obtaining the wealth germination threshold DTI score.

The said eco-system of FIG. 1 continues to issue BTD tokens till such time miners with sufficient BTD tokens net worth emerge.

Organized entities and individual datastore owners aspiring to become miners purchase sufficient BTD tokens at the token generation event.

Till time Ψ, where Ψ is the elapsed time from the first datastore user reaching the wealth germination DTI threshold and till when miners who purchased sufficient BTD tokens emerge, the eco-system of FIG. 1 continues to issue basetokens to news users to monetize their data upon reaching the threshold DTI and earn transaction fee for mining the transactions on the network. Said mining fees in turn are circulated back in the network by airdropping base tokens to new datastore owners upon reaching the wealth germination threshold.

At time Ψ miners' race to obtain the highest Ω score and win the mining rights for the next block commences. This is analogous to Sathosi Nakamoto mining the blocks till new miners entered the Bitcoin mining race of the prior art.

Time θ is that point of time after Ψ when all the users of the world are assumed to have joined the eco-system of FIG. 1 and no new datastores are expected to be generated.

Time θ is transient, if new users join the peer-to-peer data exchange ecosystem of FIG. 1 after an absence of 1 or more δ window, the previous time marker θ is considered a spurious event. During such intervals when no new user datastore are generated for miners to garner the highest Ω score, the peer-to-peer electronic data exchange eco-system of FIG. 1 randomly selects the next block mining miner.

The previous time marker θ is considered a spurious event if new user datastore are opened and achieve the wealth germination threshold DTI score.

At time θ the probability of a miner to emerge as a winner to mine the next block is 1/(1+sum of all Ω score winners till time θ).

Winning proof of data Ω score miners earn the right to mine the next Block on the said eco-system of FIG. 1. Said miners also have responsibilities to continue to generate value for this constituent datastore users.

Datastore users who vote for a miner 31 to obtain the basetokens and subsequent value are the constituents of the miner 31.

The transaction fee on the peer-to-peer electronic data exchange ecosystem of FIG. 1 is computed using the segregated witness fee computation mechanism of the known art.

The multi-signatures removed from the segregated witness-based transaction fee computation are available in the corresponding transacting datastore.

Double spend restriction on the peer-to-peer electronic data exchange eco-system of FIG. 1 utilizes the prior art bitcoin value lock and unlock mode in conjunction with the immutable transaction identification number creation mechanism.

The structure and mode of the transaction fee on peer-to-peer electronic data exchange of FIG. 1 can be changed with a simple majority vote of the miners 31. The datastore owners may override changes to the transaction fee modification with a simple majority vote.

FIG. 2 illustrates the generation of immutable transaction identification numbers 220 based on the public key address 211 of the prior art bitcoin eco-system 210.

Upon the creation of a datastore 21 in the peer-to-peer electronic data exchange of FIG. 1, the datastore is assigned an address based on the public key of the known art 221.

For the genesis transaction of the said eco-system of FIG. 2, the immutable transaction identification number is generated by concatenating the public key address 211 with a one-time transient said eco-system generated datastore and subjecting it to the method 220 of FIG. 2. Upon establishing the genesis transaction identification number for the first ever transaction on the said eco-system of FIG. 1, the transient eco-system generated datastore is deleted.

For subsequent transactions, the method 220 of FIG. 2 is repeated to generate the next immutable transaction identification number. In the event of a single datastore on the said eco-system of FIG. 1, the immutable transaction identification number is generated based on the genesis transaction identification number.

The method of generating immutable transaction identification number 220 comprises of concatenating two datastore addresses 211 or the genesis datastore address and the genesis transaction identification number 222, subsequently generating a one-time public and private key 223 using the elliptical curve multiplication of the known art and digitally signing the concatenated data from the prior stage with a nonce 224. The message digest with its time-stamp and associated public key 225 is hashed 226 once to generate A′, A′ is hashed again to generate B′. The concatenated output of A′ and B′ is TX ID′ which in-turn is concatenated with the transaction id of the prior art based; subsequently this output is subject to double SHA algorithm to obtain the immutable transaction identification number 229 on the bitcoin data network eco-system of FIG. 1.

The hashing function 226, 227 of FIG. 2 can be 256 hashing function of known art, a quantum computing resistant hashing function, or a quantum computing based hash function.

The private key 223 is a one-use private key and is deleted upon the creation of message digest 225.

The transaction identification numbers for subsequent transactions between datastore users is generated based on the previous transaction identification number thereby ensuring a unique immutable transaction identification on the peer-to-peer electronic exchange of FIG. 1. whereby all transactions within the peer-to-peer electronic data exchange eco-system of FIG. 1 are cross linked with all other transactions within the system ensuring system integrity.

Immutable transaction identification numbers are recorded by the winning miner on the decentralized transaction blockchain 10 of the said peer-to-peer ecosystem of FIG. 1.

Non-monetary transactions on the peer-to-peer electronic data exchange of FIG. 1 are conducted between datastore owners whereby all non-monetary transactions incur a transaction fee.

An example embodiment of non-monetary transaction comprises of sending and receiving emails on the peer-to-peer electronic data exchange of FIG. 1.

Datastore owners have rights, privileges and responsibilities to ensure system integrity of the peer-to-peer electronic data exchange of FIG. 1.

Datastore owners when conducting non-monetary transactions may request to have the hash signatures of the transaction content mined on the decentralized blockchain 10 of FIG. 1. An example embodiment of such a request is mining the hash of email content sent and received on the peer-to-peer electronic data exchange eco-system of FIG. 1. whereby such request incurs additional fee.

Embodiments of the invention enable a technology eco system where users maintain their sovereign data assets and can also lease the technology estate for the presence and availability of non-sovereign data assets within the eco-system of FIG. 1. Such sovereign and non-sovereign data assets can be of the type of financial and non-financial assets in singular media or multimedia and can be in the compiled or raw form and can be encrypted and non-encrypted. For non-sovereign data, the user may have the rights to use the data or may even have the rights to monetize such data. Proceeds from the monetization of the non-sovereign data assets can be split between the user and the sovereign owner of such data subject to smart contract agreements.

The sovereign owners of the non-sovereign data assets in the user technology datastore estate can be of the type of organized entities such as government entities, healthcare entities, corporate entities, nonprofit entities and individuals. Such entities holding sovereign data assets in the user's technology datastore eco system of FIG. 3 can vouch for the user's identity and establish their alibi. The owners of the non-sovereign assets in the user's datastore eco system can fully and can also partially control access to their assets. Such assets can further be controlled for its location usage intent and allied purposes. The decentralized blockchain of said eco-system of FIG. 1 is employed to log and maintain the usage of sovereign and non-sovereign assets.

Contracts are established and administrated using smart contacts 301 between the users of the said peer-to-peer data exchange of FIG. 1.

Data and application assets in the user datastore eco-system assets of FIG. 3 can be within the said peer-to-peer eco system of FIG. 1, the user-controlled technology eco system and can be on external technology eco-systems. When voluntarily participating to become a subsystem of the peer-to-peer electronic data exchange of FIG. 1, such external subsystems are subject to the structure and mode of communication of the datastore eco-system of FIG. 3.

The datastore subsystem of FIG. 3 of the said eco-system of FIG. 1 comprises of but not limited to a data truth index subsystem 310, a smart contracts library to monitor and enforce contracts 301, an artificial intelligence engine 330 for analyzing, securing, detailing summarizing, scoring, pricing and performing allied operations on the data and applications assets, a wallet with the datastore address managing the user bitcoin data BTD coins 340 and validating transactions on the network when required, an API gateway for managing and facilitating internal and external system access 350, an API management platform for facilitating and safeguarding logic execution 360, a Compute Brokers Cloud/Quantum for obtaining processing resources on private, public or quantum environments 370. Additionally, the datastore 300 subsystem comprises of an email communication subsystems 381, a social networking communication subsystem 350, a text and voice communication subsystem, and a general distributed applications subsystem 370 for delivering external application of the example type of but not limited to distributed ecommerce, commerce communities, tax reporting, collection and regulatory compliance, software as a service delivery, asset tokenization, dating and match making and allied decentralized applications of universal applicability in business to business, business to consumer and consumer to consumer environments. The datastore 300 subsystems also comprise of storage 390 logically connected and behaves as native storage on public, private and quantum computing environments. It also includes external oracle connectors 341 to connect, obtain, synchronize, secure and manage external inputs and outputs 340.

Datastore users holding BTD may elect to purchase product and services offered by dAPPs subsystem; an example embodiment of such activities comprises of but not limited to datastore owners purchasing product and services from an ecommerce dAPP. with their BTD earned from datastore based data assets.

An example external oracle 341 embodiment of the invention includes a global position GPS data input from the user's mobile device with GPS data collection and made available for compensation.

The external data and assets 340 are linked to the eco-system of FIG. 1 by means of external oracle connector 341.

The assets in the user datastore eco-system 20 are managed, controlled and administered in real-time and near real-time, and are activated and deactivated in manual mode, automated mode or semi-automated by one or more users and one or more systems of the said eco-system of FIG. 1.

The technology eco-system of FIG. 1 is maintained and administered in real, virtual and quantum computing environments.

Embodiments of the invention enable peer-to-peer email communications 381, peer to peer social networking 382, and peer to peer text and voice chat conversations 383.

Embodiments of the invention enable peer-to-peer distributed applications or dAPPS 384 by native users or through external oracles 340 and 341

Data and application assets of the datastore of FIG. 3 are under the sovereign control of the datastore owners.

Distributed email 381 in the datastore has chambers for personal and corporate or work email. A chamber comprises a portion of the Organized entity email 381, social networking 382, chat communications 383, dAPPs 384 deposited in the user datastore 300 may be controlled by the issuing entity or any user or entities on behalf of the issuing entity.

Compensation for the datastore 300 assets of FIG. 3 is negotiated and enforced by the smart contracts library 301 whereby transactions resulting from such negotiations are recorded on the decentralized blockchain 10 of FIG. 1.

The datastore of FIG. 3 enables the user to interact with their smart contracts to configure maintain the compensation settings; said settings can be maintained by external entities with the permission of the sovereign owner of the datastore 300.

External data and assets hosted in the user datastore may incur a fee paid to the datastore owner; such transactions are subject to the rules of the eco-system of FIG. 1.

Access to external assets hosted in the user datastore 300 may be revoked by the external entities subject to the contract enforced by the smart contract library 301.

Communication on the peer-to-peer eco system of FIG. 1 incur a transaction cost payable to the winning miner. The datastore may request to create the hash of the email and broadcasts it on the blockchain for mining; the winner of the next block mines the hashes on the blockchain for a transaction fee.

Non-monetary transactions on the eco-system of FIG. 1 of the example type of sending bulk email may have tiered transaction fee.

Emails and other communication between users within the peer-to-peer electronic data exchange eco-system of FIG. 1 are transmitted and received using the unique datastore address. The distributed email application in the datastore provides the user to associate their identity to their datastore email address. Transactions on the decentralized main chain 10 validates the user upon the establishment of the threshold DTI.

For email delivery within and outside of the peer-to-peer eco-system of FIG. 1, the eco-system facilitates the “send, receive” in a decentralized manner.

An example subsystem of the user datastore 300 of FIG. 3. comprises of but not limited to usage, monitoring and security software, ad center, compute broker on private or public service provider platforms. Said software of the example decentralized email sub system 381 comprises of software that interacts with a smart contract that enforces terms of access and usage. All message content is encrypted utilizing technologies of the know art or of quantum computing and stored in private or public cloud or an interplanetary file system IPFS; a peer-to-peer storage network. Eco-system users opting in an eco-system service may also opt in advertisement delivery; the monetary compensation of participating in the advertisement services is enforced by the smart contract library 301 and the BTD cryptocurrency proceeds are deposited in the user's datastore wallet 340.

I claim:

1. A system for generating, issuing and recording value transactions, the system comprising:
a decentralized datastore layer operable to generate a value;
a decentralized permission-less blockchain layer operable to execute a proof of data consensus for determining a winning miner and recording transactions on variable block-size ledgers;
a decentralized value issuing layer operable to issue a value,
wherein the decentralized datastore layer is operable to store, execute, secure, analyze, negotiate, score and price a plurality of data and application value-generating assets, wherein the decentralized datastore layer comprises:
a data truth index module,
a wallet,
a smart contracts library,
an artificial data analysis engine,
an application programming interface (API) gateway,
an application programming interface (API) management subsystem,
a compute broker,
decentralized email, social networking, voice and text chat subsystems,
a distributed application (dApps) subsystem,
a storage subsystem; and
allied subsystems,
wherein the peer-to-peer electronic data exchange airdrops basetokens and mines transactions until the emergence of network miners; and
wherein said transactions are monetary and non-monetary transactions.

2. The system according to claim 1, wherein the value issued is selected from the group consisting of a monetary value, an identification value, a behavior value, a licensing value and an allied value.

3. A method for maintaining the integrity of the peer-to-peer electronic data exchange by generating an immutable transaction identification number, comprising the steps of:
computing an immutable transaction identification number utilizing algorithms selected from the group consisting of Secure Hashing Algorithms (SHA) family of algorithms; emerging and Shor's proof quantum computer algorithms, and quantum computing encryption algorithms.

4. The method according to claim 3, wherein the immutable transaction identification number is generated by leveraging a bitcoin address and a bitcoin transaction identification number.

5. A method for providing a peer-to-peer electronic data exchange eco-system comprising the steps of:
using a permission-less blockchain operable on proof of data consensus, wherein a block winning miner is determined by obtaining the highest proof of data consensus score as determined by a value issuing entity by issuing basetokens to sovereign datastore owners;
attaining a threshold data truth index score wherein the proof of data consensus score is determined by compiling data truth index scores during time t−1 and time t,
establishing contending proof of data score winners based on criteria selected from the group consisting of the total number of times a contender node became unavailable during block mining operations, wherein a higher winning weightage is awarded to fewer times a contender node was unavailable; a total number of datastore users signed up with the contender, whereby the higher the number of signed-up datastore users, a higher winning weightage is awarded; total time for the sovereign datastore owner to attain a wealth germination threshold, wherein the lower the total time taken, a greater winning weightage is awarded; the net worth of the sovereign datastore owner, wherein the greater the net worth of the sovereign datastore owner, a greater winning weightage is awarded; an expected income of the sovereign datastore owner, wherein the greater the income, a greater winning weightage is awarded; a net bitcoin data worth of the sovereign datastore owner, wherein the greater the value of the bitcoin owned by the sovereign datastore owner, a greater winning weightage is awarded; the age of the datastore owned by the sovereign datastore owner, wherein the greater the age of the datastore owned by the sovereign datastore owner, a greater winning weightage is awarded; individual sovereign datastore owners are awarded a greater winning weightage than organized sovereign datastore owners; number of times a sovereign datastore owner won block mining rights prior to time t, wherein the greater the number of times the sovereign datastore owner won block mining rights prior to time t, a greater winning weightage is awarded; when last a sovereign datastore owner won the block mining rights prior to time t, wherein the closest to time t that the sovereign datastore owner won block mining rights prior to time t, a greater winning weightage is awarded; a data truth index score of a sovereign datastore owner, wherein the higher the data truth index score, a greater winning weightage is awarded; a total number of basetokens a sovereign datastore owner issued prior to time t, wherein the greater number of basetokens issued by the sovereign datastore owner, a greater winning weightage is awarded; an early initial issuance of basetokens by a sovereign datastore owner, wherein the earlier a sovereign datastore owner issues basetokens, a greater winning weightage is awarded; the total value of transactions not recorded in real-time by a sovereign datastore owner prior to a block expiry window, wherein the lower the value a greater winning weightage is awarded to the lower total value.

6. The method of according to claim 5, wherein the method for providing a peer-to-peer electronic data exchange eco-system is repeated with a new block winning miner selected randomly from a pool of block winning miners during time t−1 and time t when no new datastores reach a wealth germination threshold.

7. The method according to claim 5, further comprising the step of establishing a genesis transaction identification number by creating a transient system generated datastore.

8. The method according to claim 5, wherein the sovereign datastore owner pairs up with a contesting miner.

9. The method according to claim 8, wherein the contesting miner who receives the highest proof of data score is the next contesting miner to mine the next block and earn transaction fees.

10. The method according to claim 8, wherein the value issuing entity that determines the highest proof of data consensus score issues basetokens to datastore owners and obtains a lease for a designated period of time to data assets that appreciate in value during said lease period.

11. The method according to claim 10, wherein the data assets lease is enforced by a smart contracts' library.

12. The method of according to claim 13, wherein the basetokens maintain parity to a government issued currency, wherein the amount of basetokens double in amount upon reaching a 2-unit value of a government issued currency and, wherein the amount of basetokens remains unchanged upon decrease in the value of the government issued currency.

13. The method according to claim 5, wherein sovereign datastore owners contesting to become miners purchase bitcoin data tokens at a token generation event from a peer token holder.

14. The method according to claim 5, wherein the basetokens are awarded to sovereign datastore owners upon reaching a wealth germination threshold.

15. The method according to claim 5, wherein said monetary values are in cryptocurrency and said cryptocurrency is bitcoin data.

16. The method according to claim 5, wherein a digital alibi for a sovereign datastore owner using the eco-system is established based on the sovereign owner's datastore assets and the sovereign owner's transactions mined on the blockchain.

17. The system according to claim 1, further comprising
block shards; and
a bitcoin data network;
wherein the block shards are broadcast on the bitcoin data network upon reaching a miner-established broadcast threshold.

18. The system according to claim 1, wherein the distributed application (dApps) subsystems comprise:
decentralized eCommerce applications;
decentralized tax reporting and regulatory applications;
decentralized dating applications;
a decentralized software as a service (SaaS) application;
decentralized asset tokenization applications; and
allied decentralized applications of universal applicability.

19. The system according to claim 1, further comprising an operable compute platform situated in an operating system selected from the group consisting of a data center, a private cloud, a public cloud, a hybrid cloud, and a quantum computing environment.

20. The system according to claim 8, wherein said transaction incurs a fee and the contesting miner receives basetokens when pairing up with a sovereign datastore owner.
